(19) United States
(12) Patent Application Publication
(10) Pub. No.: US 2011/0076654 A1
(43) Pub. Date: Mar. 31, 2011

(54) METHODS AND SYSTEMS TO GENERATE PERSONALISED E-CONTENT

(76) Inventors: Nigel J. Green, Bellevue, WA (US); Mickelle Weary, Kirkland, WA (US)

(21) Appl. No.: 12/895,737

(22) Filed: Sep. 30, 2010

Related U.S. Application Data
(60) Provisional application No. 61/247,505, filed on Sep. 30, 2009.

(51) Int. Cl. G09B 5/00

(52) U.S. Cl. 434/169

(57) ABSTRACT

Systems and methods for generating reading recommendation are disclosed. In one example embodiment a reading material is sent as e-content to a reading device. An evaluation process is executed to evaluate a reader's reading ability based on the reading material. The evaluation process may take as first input data collected from the reading device. A recommendation process is executed to identify a reading recommendation for the reader based on the reader's reading ability and the reading recommendation is provided to the reader.

This application claims the benefit of priority to U.S. Provisional Patent Application No. 61/247,505 filed Sep. 30, 2009, the entire specification of which in incorporated herein by reference.

### BACKGROUND

E-content refers to content that is available in electronic format. Examples of e-content include written material such as articles, essays, poems, books, and the like. E-content may also include teaching material e.g. in the form of interactive lessons.

If e-content is not matched to a particular consumer of the e-content, then there is a danger that the consumer might not gain the maximum benefit and/or enjoyment from the e-content. Thus, for example, in the case of a reader, if the reading material is too difficult or too ease then the reader may become frustrated or bored with the reading material.

### BRIEF DESCRIPTION OF THE DRAWINGS

Various embodiments are described herein with reference to the drawings, wherein:

FIG. 1 illustrates a flow diagram of a method for generating a reading recommendation, according to an embodiment;

FIG. 2 illustrates a block diagram of a system for generating a reading recommendation, according to an embodiment;

FIG. 3 illustrates a block diagram of another system for generating a reading recommendation, according to an embodiment;

FIG. 4 illustrates a screenshot depicting an introductory level word sort exercise, according to an embodiment;

FIG. 5 illustrates a screenshot depicting an advanced level word sort exercise, according to an embodiment;

FIG. 6 illustrates a screenshot depicting an exercise for identifying similar vowel sounds, according to an embodiment;

FIG. 7 illustrates a screenshot depicting an exercise for identifying a correct spelling, according to an embodiment;

FIG. 8 illustrates a screenshot depicting an exercise to create words from parts, according to an embodiment;

FIG. 9 illustrates a screenshot depicting an exercise for grammar, according to an embodiment;

FIG. 10 illustrates a screenshot depicting an exercise to create sentences from parts, according to an embodiment;

FIG. 11 illustrates a block diagram of a yet another system for generating a reading recommendation, according to one embodiment;

FIG. 12 illustrates a block diagram of a yet another system for generating a reading recommendation, according to one embodiment;

FIG. 13 illustrates a block diagram of a yet another system for generating reading recommendation, according to one embodiment; and

FIG. 14 illustrates a block diagram of a yet another system for generating a reading recommendation, according to one embodiment.

The drawings described herein are for illustration purposes only and are not intended to limit the scope of the present disclosure in any way.

### DETAILED DESCRIPTION

A system and method for generating a reading recommendation is disclosed. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined by the appended claims.

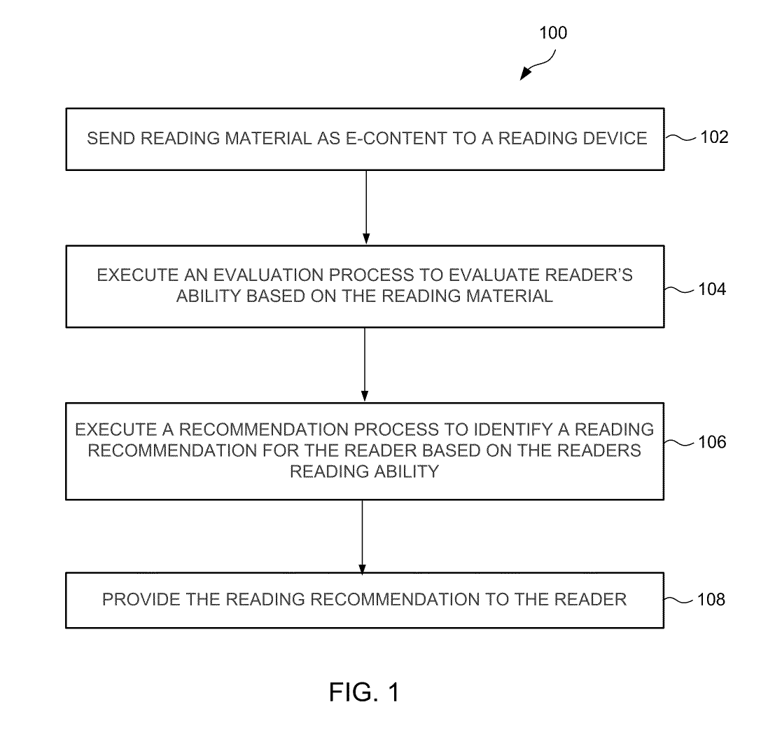

FIG. 1 illustrates a flow diagram of an exemplary method 100 for generating a reading recommendation, according to an embodiment. The reading recommendation may be generated for reading for enjoyment, reading for leisure, reading for learning a curriculum, reading for learning a language, reading for improving vocabulary and for any other purpose, for a reader. The reading recommendation may be generated using a server accessible to a reading device via a communication system. The reading recommendation may also be generated on the reading device itself.

At block 102 of FIG. 1, reading material is sent as e-content to the reading device. The reading device may be a multi-media device. The reading device may be a computing device. As an example, the reading device may be a smart phone, handheld computer, a tablet personal computer, a laptop computer and a personal computer. As another example, the reading device may be software and a hardware platform developed for rendering and displaying the e-contents, i.e., Amazon Kindle and/or Apple iPad. The reading material may be sent to the reading device from a server device via a communication system. As an example, the reading material for the tablet personal computer may be sent using the internet. As another example, the reading material for the smart phone may be sent using the internet or a telephone service carrier.

At block 104, an evaluation process is executed to evaluate reader's ability based on the reading material. The evaluation process may be executed on the server connected to the reader's device or the reader device. The evaluation process may take as first input data collected from the reading device. The first input may include metrics collected as the reader reads the reading material. The metrics may comprise information about dictionary look-ups the reader performed while reading. The metrics may comprise information about definition look-ups the reader performed while reading. The dictionary look-ups may comprise searching for a meaning of a word in a dictionary. The dictionary look-ups may be performed on the dictionary provided on the reading device or on an online dictionary accessible to the reader. The definition look-ups may comprise looking for a definition of a word by the reader in a handbook or a reference book. The definition look-up may comprise looking for details about a word, a phrase, an event, etc. on online search engines such as Wikipedia. The metrics may include the reader's notes about the texts, words or phrases in the reading material.

The metrics may further include reader's inputs to one or more tests/exercises administered by the reading device and designed to test the reading ability of the reader. The metrics may further include data indicative of at least one of the reader's level of phonemic awareness, vocabulary, reading comprehension and reading level. The levels of phonemic awareness, vocabulary, reading and reading comprehension for the reader/learner may be determined by analyzing the reader's responses to one or more of the following questions:
(i) How well may the reader spell dictated words of varying difficulty and what types of mistakes does the reader make (e.g. does the reader enter “sellary” instead of “celery”)?
(ii) How well does the reader recognize the correct pronunciation of words?
(iii) How well does the reader match words to the correct definitions when provided with multiple alternatives?
(iv) How well does the reader place words into the correct locations with sentences?
(v) How well does the reader identify parts of speech (e.g. noun, verb, adverb, etc.)?
(vi) How well does the reader comprehend passages of text the reader is asked to read? Can the reader summarize, or choose an accurate summary from amongst alternatives? How well does the reader understand any metaphor or simile used within those texts?

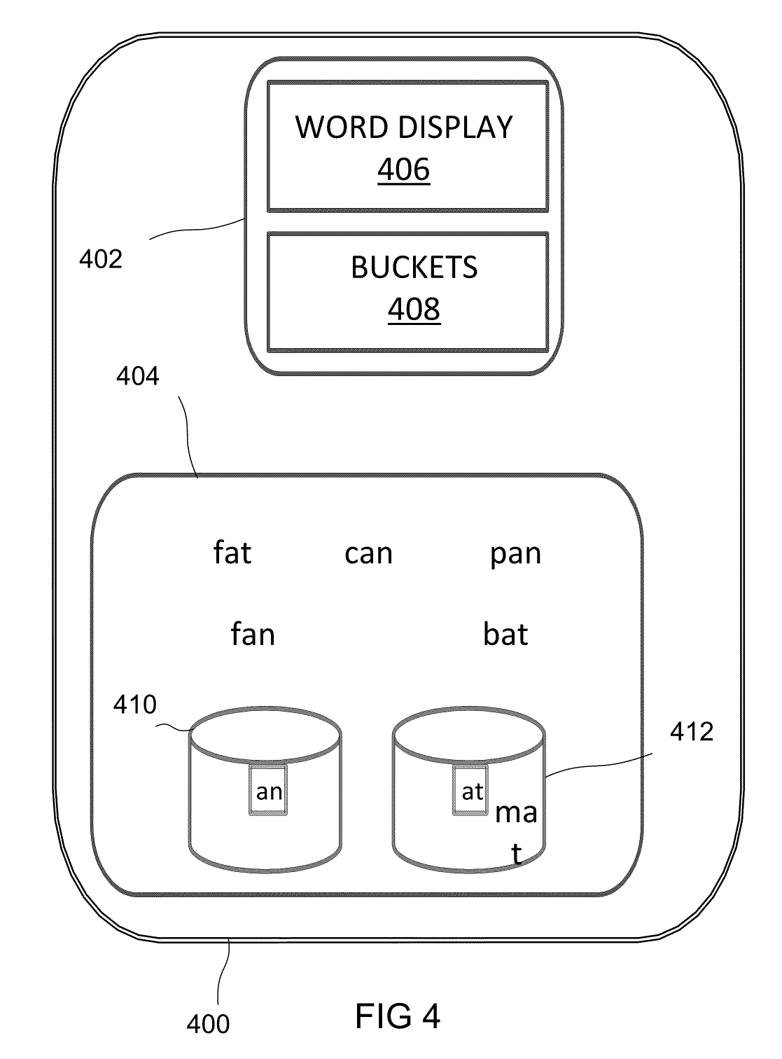

According to an embodiment, the above mentioned questions may be presented to the reader in form of exercise and/or tests. As an example embodiment, the tests administered by the reading device to evaluate the readers reading ability may include the following: word sort, identify the correct spelling, identify the same vowel sound, create words from parts, create sentences from parts, categorizing mistakes, finding mistakes and correcting mistakes. The tests may also be used to evaluate the reader's level of phonemic awareness, vocabulary, reading comprehension, and reading level. These tests are explained with respect for FIGS. 4 to 10.

The tests administered by the reading device may include a series of difficulty levels for each of the tests. For example, the tests may start with level one and depending on the responses from the reader; the difficulty level of the questions may increase. For example in the word short test, the test may start with shorting vowels and consonants in different buckets for a beginner. For an intermediate reader the word sort test may include sorting the words based on their meaning or definitions. Once the reader makes significant mistakes, the tests are discontinued and an overall score and a developmental level determined. For example, if the reader is unable to sort 50% of the words, the word test may be discontinued and the overall score of the reader may be determined based on the level of the word sort test.

The reader's input may include at least one of inputs indicative of reading interests and reading level. The reading interest may be specified in terms of reading for enjoyment, reading for learning and reading for a curriculum. The reading for interests may further be specified in terms of types of texts, type of genre, authors and subject matters the reader may read. As an example the reader may input that he/she enjoys reading scientific fiction novel. The reader may further input that he enjoys reading scientific fiction novels from one or more authors. The reader may input that he likes reading a particular series of books for learning a language.

The reading level may be specified in terms of job titles. As an example the reading level may be specified as that of a lawyer, a doctor, a scientist, a manager, a teacher and a language learner. As an example, the reader may specify that he wants to achieve a reading level of a lawyer. The reading level may be specified in terms of goals. For example the reader may define a level of vocabulary the reader wishes to learn in next three months, six months and one year. As another example, the reader may define his current reading level and goal for the next one year. As another example the reading level may be specified in terms of grade level for a student.

At block 106, a recommendation process is executed to identify a reading recommendation for the reader based on the reader's reading ability. The recommendation process may be executed in the server in communication with the reading device. The recommendation process may be executed on the reading device itself. According to an embodiment, the reading recommendation for the reader based on the reader's reading ability and external constraints. The external constraints may include reading items required by a school curriculum, reading items excluded by the school curriculum, texts from one or more publishers, texts available in a classroom or a school library, texts by authors or texts in a series the reader is progressing through. For example, the reading recommendation may be based on the reading ability of the reader and the curriculum of the reader for his classroom. As another example the reading recommendation is based on the reading ability of the reader and the publishers publishing the books in the reader's area of interest.

According to an embodiment, the reading recommendation generated for the reader may be allowed for overrides. As an example, if the reader is a student, the reading recommendations may be modified by his instructor using the override option. The instructor may be a teacher, parent or guardian. The overrides may allow the instructor to remove, add or change one or more items in the reading recommendation. The overrides may also allow an instructor to change a priority of the items in the recommended reading list.

At block 108, the reading recommendation is provided to the reader. The reading recommendation may be provided in form of texts, dictionary of words and texts comprising words of the dictionary. In one implementation the recommended reading may consists of texts at the reader's instructional reading level, texts at the reader's independent reading level and texts that are suitable to buy now or later. The texts at the reader's instructional reading level may comprise words, phrases, or material that the reader may struggle to read with unless assistance is provided. The assistance may be provided by the instructor or the parent of the reader. The texts at the instructional reading level are generated for the instructor or the parent. The texts at the reader's independent reading level may comprise words, phrases, or material that the reader may read by himself without any assistance. The texts at the reader's independent reading level are unlikely to contain words or material that would cause the reader difficulty. The texts that are suitable to buy now for later may contain texts which may be placed on a wish list or used as presents for the reader. The texts that are suitable to buy now for later may contain texts which the reader may be recommended in coming future based on his current reading ability. In one example implementation of the texts that are suitable for “buy now for later” may, for example, categorize texts to read into the following areas:
i. Texts the reader will likely be able to read (or will be recommended to read) in the next 1-3 months.
ii. Texts the reader will likely be able to read (or will be recommended to read) in the next 3-6 months.

According to an exemplary embodiment, the reading recommendation may include a short term target vocabulary based upon an assessment of the reader's reading abilities and goals of the reader. The short term target vocabulary may be generated by combining an analysis of the reader's current vocabulary with both a desired vocabulary and those words derived from probable near future reading. In one implementation a desired vocabulary may be set as part of a curriculum specification and the near future reading may be generated from the words of the texts on the target reader's independent reading and buy now for later reading lists. In another implementation the future reading may comprise texts the reader has expressed an interest in or intent to read. In yet another implementation the future reading may include texts the reader is required to read for specific educational or business reasons.

In one embodiment the short term target vocabulary may be used when generating the reading recommendation and exercises. In one implementation the reading recommendation and exercises may be generated in form of instructional material and/or lessons using the short term target vocabulary that addresses one or more of the following goals:
Reinforcing and extending the use of the words and phrases the reader is already familiar with.
Reinforcing and increasing the familiarity and use of the words recently encountered through both reading and other instructional exercises.
Introducing to the reader new words and phrases from the short term target vocabulary that the reader may or may not have encountered before.
Providing assistance in the reading, understanding and correctly use of the words in the short term target vocabulary.

According to an embodiment, a readers' profile may be created to track the progress of the reader. The readers profile may be created on the reading device or, a server accessible to the reading device. The reader's profile may comprise starting reading abilities, the current reading abilities and the recommended readings of the reader. The reader's profile may further comprise the tests presented to the reader and the reader's response to the tests. The reader's profile may further comprise data of dictionary look-ups and definition look ups by the reader, the texts the reader reads, the goals of the reader, the other texts reader reads, and other information related to the reader's reading abilities. As an example for the student, the profile may include the grade, the curriculum, the lessons, current vocabulary, target vocabulary, lessons generated, tests conducted, scores of the tests conducted, and other such information for the student.

According to an embodiment the method for generating reading recommendation is a dynamic process. The method may use inputs for the readers and/or instructors to dynamically determine their reading abilities. The method may further dynamically generate the reading recommendations based on the reading abilities of the reader. The reading recommendations may be of different length and formats depending on the age and level of the reader. For example, for young readers at lower levels, the reading recommendation may be short texts or phrases. As another example, for the young readers at lower levels the reading recommendation may comprise reading in forms of games to keep their level of interest. The method may be configured to conduct the evaluation of the reading abilities of the reader at a predetermined time intervals. For example, for young readers, the tests may be conducting while they are playing by presenting the tests in form of games. As another example, for young readers the test may be conducted in many phases in short intervals to avoid losing the interest levels of the reader.

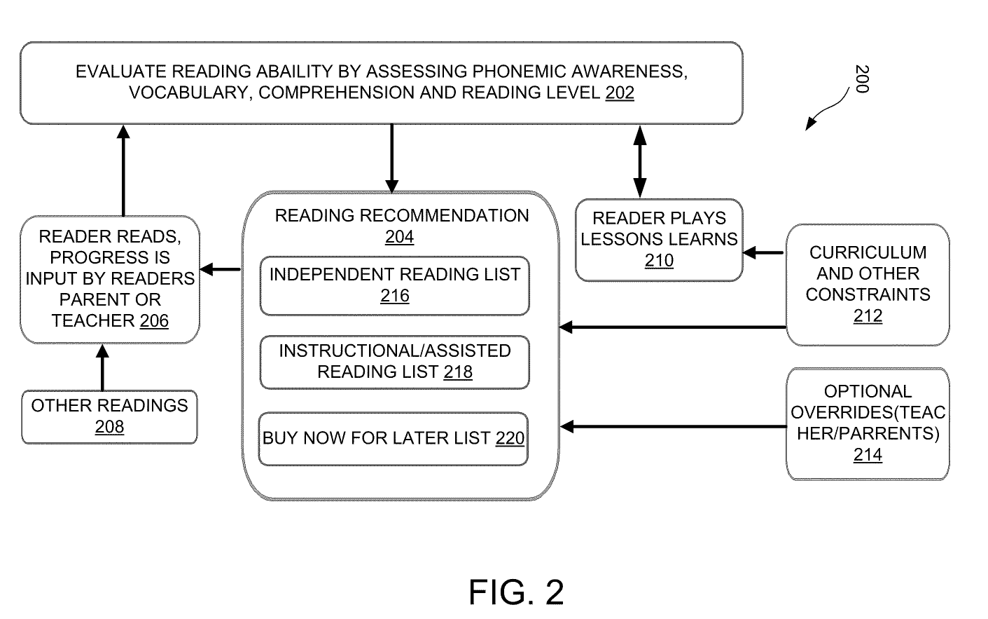

FIG. 2 illustrates a block diagram of a system 200 for generating a reading recommendation, according to an embodiment. The system 200 may be used to generate reading recommendation for a student based on the reading ability of the student. At block 202, the reading ability of the reader is evaluated by assessing phonemic awareness, vocabulary, reading comprehension and reading level. The reading ability may be assessed by analyzing inputs from the reader for one or more assessment tests related to phonemic awareness, vocabulary, reading comprehension and reading level.

At block 204, a reading recommendation is generated for the reader. The reading recommendation may be generated based on the evaluation of the reading ability of the reader. The reading recommendation 204 may comprise an independent reading list 216, instructional/assisted reading list 218 and buy now for later list 220.

At block 206, the progress of the reader may be input by student parent or teacher as the student reads. The reader's progress may be feed into the reading device. At block 208, other readings may be used for providing the input by the reader's parent or teacher. The other readings may include readings other than the reading recommendation generated by system 200. For example the other readings for a student may include comic books and text books from classroom lessons. The reader's progress is used to update the reading abilities of the reader. For example, based on the input from the teacher, the student reading ability is upgraded.

At block 210, the reader may learn his lessons while he is playing. The reading recommendation may be provided in form of games. For example the reading recommendation may be provided in form of word games, multimedia games and/or toys games. At block 212, curriculum and other constraints may be applied on the reading recommendation. The curriculum and other constraints may be defined by the reader's instructor, parents or teacher.

At block 214, the reading recommendation is provided with optional overrides. The optional overrides may be exercised by the reader's instructor. The instructor may be a teacher or parent. The overrides may be used to modify the reading recommendations by changing texts of the contents, changing the order of the contents, and so on.

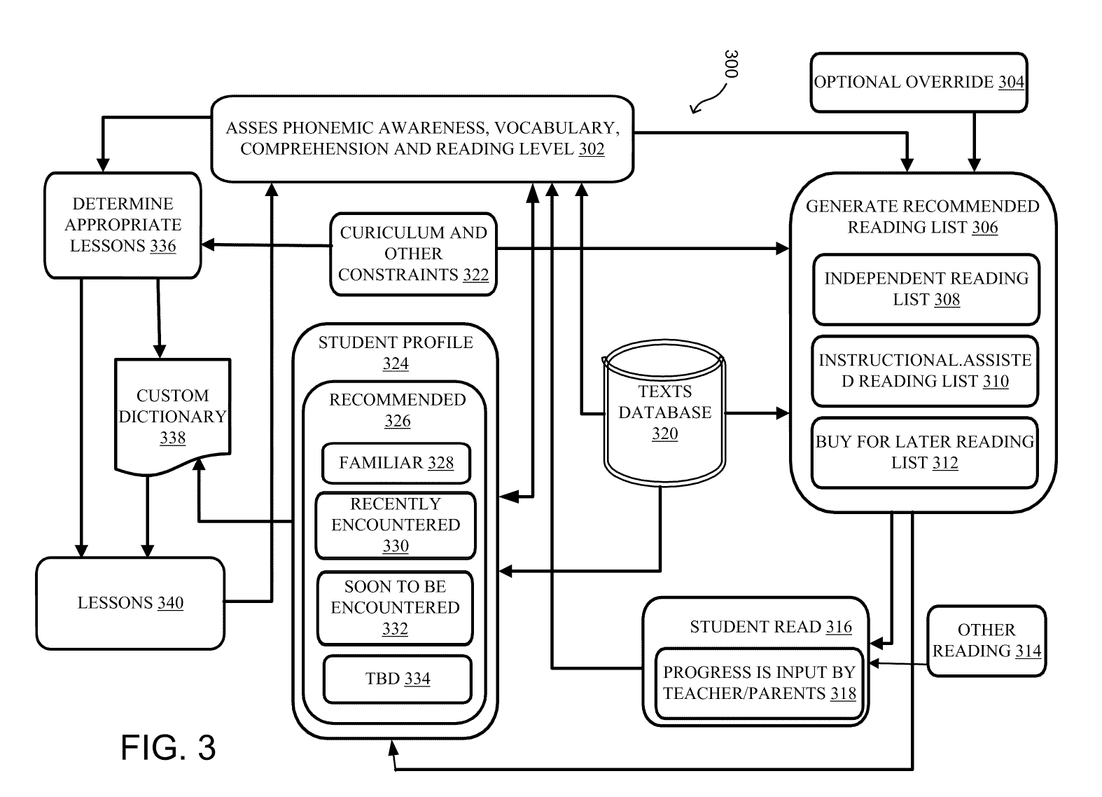

FIG. 3 illustrates a block diagram of another system 300 for generating reading recommendation, according to an embodiment. The system 300 may be used to generate the reading recommendations for a student based on his reading abilities. At block 302, reading ability of the student is determined by assessing phonemic awareness, vocabulary, comprehension and reading level. The reading ability may be determined by analyzing response of the student for one or more tests. The reading ability of the student may also be determined by the student's teacher or parent.

At block 306, a reading recommendation is generated for the student based on the reading ability of the student. The reading recommendation 306 may comprise an independent reading list 308, instructional/assisted reading list 310 and buy for later reading list 312. The reading recommendation may be generated based on the evaluation of the reading level of the student and external constraints 322. The external constraints 322 may comprise curriculum of the school or a subject in his classroom. The reading recommendation may be generated by the students reading device or a server accessible to the student reading device. At block 304, the reading recommendation is provided with optional overrides. The optional overrides may be exercised by the student's instructor to modify the recommended reading list. The instructor may be a teacher or parent.

At block 316, the student may read the reading recommendation. The student may read the reading recommendation on the reading device. The reading device may be a computing device, for example, a tablet personal computer, a laptop computer, a multimedia, device, etc. The reading device may be an Amazon Kindle device and/or a Apple iPad device. At block 318, the teacher and/or the parent may input the progress made by the student. The teacher and/or the parent may input the progress report in the evaluation block 302. At block 314, the teacher and/or the parent may input a progress of the student based on other reading apart from the reading recommendation generated by the system 300. The progress report of the student may be used to update the reading abilities of the student.

At block 320, a text database may be used to generate reading recommendations and evaluating the students reading level. The text data base may be created and stored in the reading device or the server.

At block 324, a student profile may be created. The student profile may comprise a list of recommended reading 326 for the student. The list of recommended reading 326 for the student may comprise a list of familiar readings 328, recently encountered readings 330, soon to be encountered readings 332 and to be decided readings 334. The soon to be decided readings may be reading recommendation for the future reading. The student profile may be created based on the evaluation of the reading level of the student and the reading recommendation generated for the student.

At block 336, appropriate lessons may be determined for the student based on the recommended readings generated for the student. The appropriate lessons for the student may be determined based on the evaluation of the student level and external constraints. At block 338, a custom dictionary may be generated for the student. The custom dictionary may be generated based on the appropriate lessons for the student and the student profile. The custom dictionary may comprise a list of words which student should read. The custom dictionary may comprise short term target words and long term target words. At block 340, lessons may be selected for the student based on the custom dictionary and the appropriate lessons determined at block 336. The lessons may be provided to the student on the reading device. The selected lessons may be used for evaluating the student reading level after the student has completed learning the selected lessons.

FIG. 4 illustrates a screenshot 400 depicting an introductory level word sort exercise, according to an embodiment. In the introductory level word sort exercise the reader may be asked to sort words into buckets based upon requirements. There may be more than one implementation of the introductory level word shorts. As an example, the variations may include number of baskets, number of words on screen at once, duration words on the screen, words similarities, word differences and word complexity.

The screenshot 400 depicts an introductory level word sort exercise for shorting words based on the ending of the words. The screenshot 400 includes a format 402 of the introductory word sort and introductory word sort exercise 404. The format may include words display format 406 and buckets format 408. The introductory word sort exercise 404 may include two buckets, bucket 410 and bucket 412. The bucket 410 is for sorting words ending with ‘an’ and bucket 412 is for sorting words ending with ‘at’. The introductory word sort exercise 404 may further include words to be sorted into the buckets. During the test, the reader is asked to sort the words ending with ‘an’ in bucket 410 and the words ending with ‘at’ in bucket 412. The words to be sorted may animate on the screen. The words to be sorted may further fade in and out on the screen. In one implementation the words to be sorted may be visible for a limited time or for a time till the words are sorted. In another implementation images may be used in place of words. The words or images to be sorted may support audio rollover.

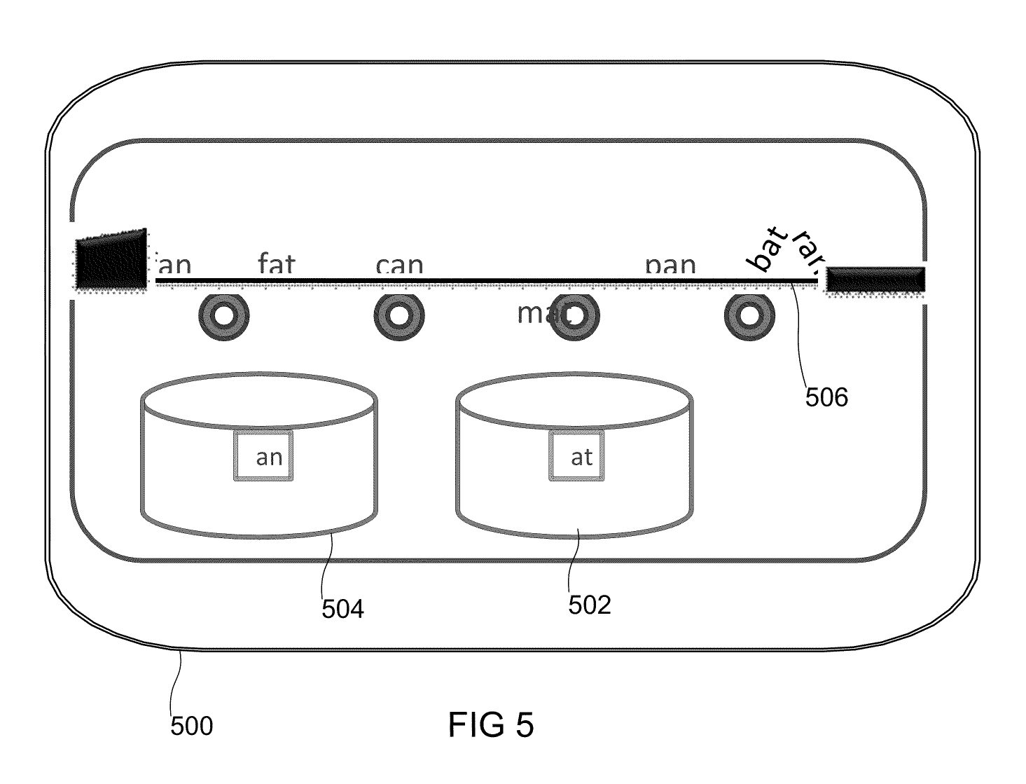

FIG. 5 illustrates a screenshot 500 depicting an advanced level word sort exercise, according to an embodiment. The advanced level word sort includes a conveyer belt 506, a bucket 502 and a bucket 504. The bucket 402 is for sorting words with ending ‘an’ and bucket 404 is for sorting words with ending ‘at’. The words to be sorted are presented on the conveyer belt 506. The conveyer belt 506 moves words to be sorted from left to right. During the test, the reader is asked to sort the words ending with ‘an’ in bucket 502 and the words ending with ‘at’ in bucket 504. In one implementation any unsorted words cause traffic jam when it cannot go through an exit tube. In another implementation if too many words pile up, the line stops until the jam is cleared. In yet another implementation the words to be sorted may slowly rain down from the top of the screen. The words with a certain ending need to be caught or short before it hits the ground.

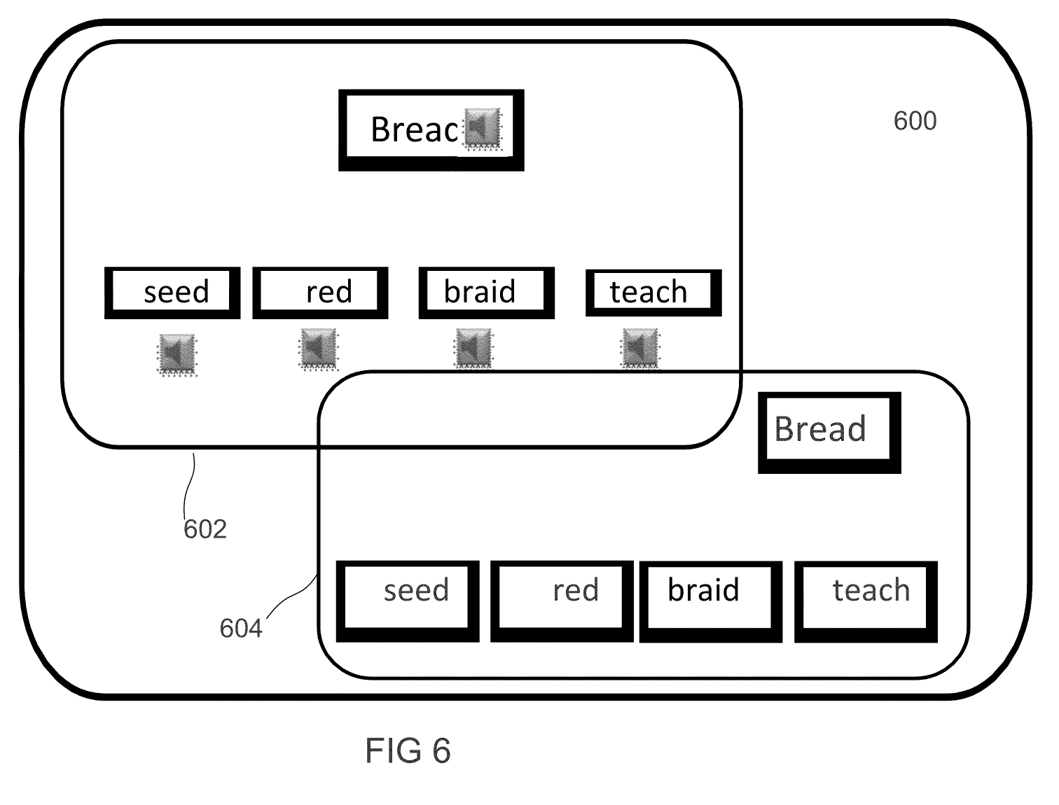

FIG. 6 illustrates a screenshot 600 depicting an exercise identifying a same volume sound, according to an embodiment. The screenshot 600 includes an introductory level exercise 602 and advanced level exercise 604. The introductory level exercise 602 consists of a word displayed on the screen of the reader and an optional audio for pronouncing the word. The screen of the reader may further comprise four words with optional audio for pronouncing each word. In the advanced level exercise 604 does not include any audio.

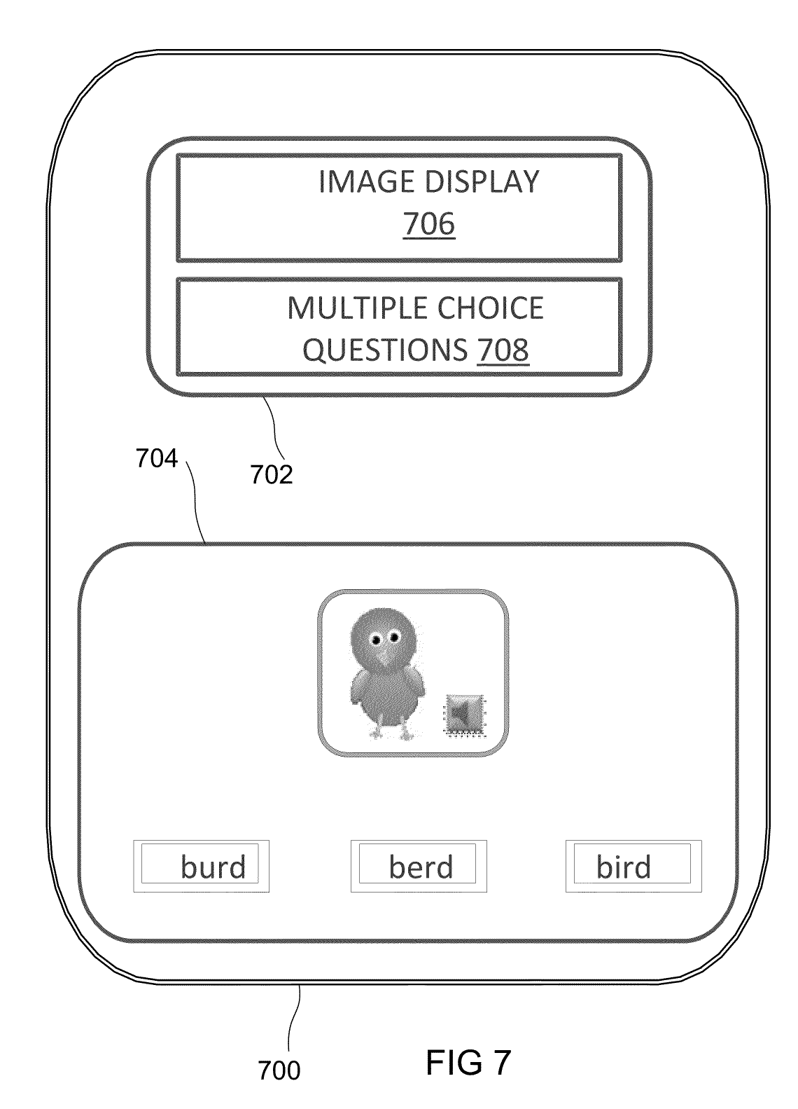

FIG. 7 illustrates a screenshot 700 depicting an exercise to for identifying a correct spelling, according to an embodiment. During the exercise the reader may be asked to select a correct spelling for a word from amongst a set of distracters. There may be more than one implementation of the exercise for identifying the correct spelling. In one implementation the number of distracters may be variable. In another implementation the word is initially spoken. In yet another implementation word is used in a sentence.

The screenshot 700 includes a format 702 of the exercise and the contents of the exercise 704. The format 702 includes an image display format 706 and multiple choice format 708. The contents 704 includes an image of a bird and three different spellings for the word bird. During the exercise the reader is asked to choose the right spelling of the name of the image displayed on the screen. In one implementation the reader is asked to select a correct spelling for a word from amongst a set of distracters.

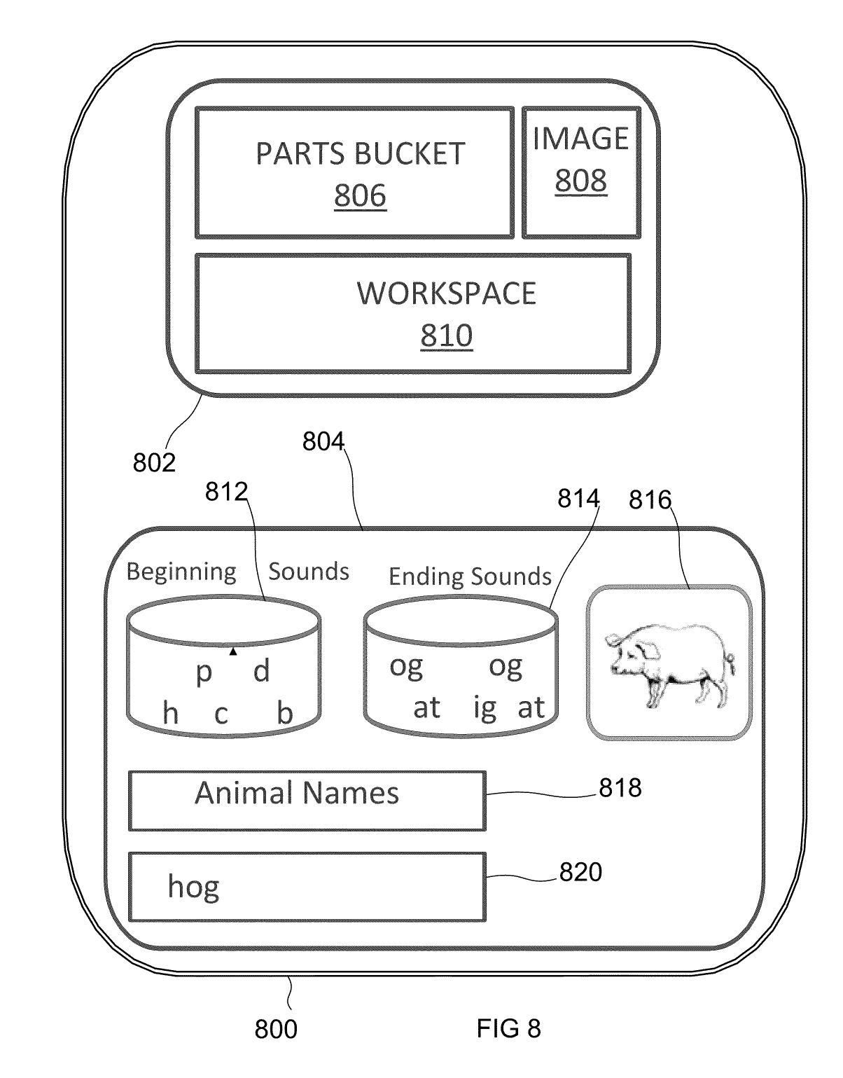

FIG. 8 illustrates a screenshot 800 depicting an exercise to create words from parts, according to an embodiment. The screenshot 800 includes format 802 of the exercise and the contents 804 of the exercise. The exercise 802 includes format for parts bucket 806, format of an image 808 and format for workspace 810. The contents of the exercise 804 includes a bucket for beginning sounds 812, a bucket for ending sounds 814, a image of the word 816, type of the word 818 and a workspace 820 for entering a response. During the exercise the reader is asked to spell the name of the image in the workspace using the beginning sounds and ending sounds from bucket 812 and bucket 814. In one implementation the bucket 812 and bucket 814 may include finite or infinite number of words.

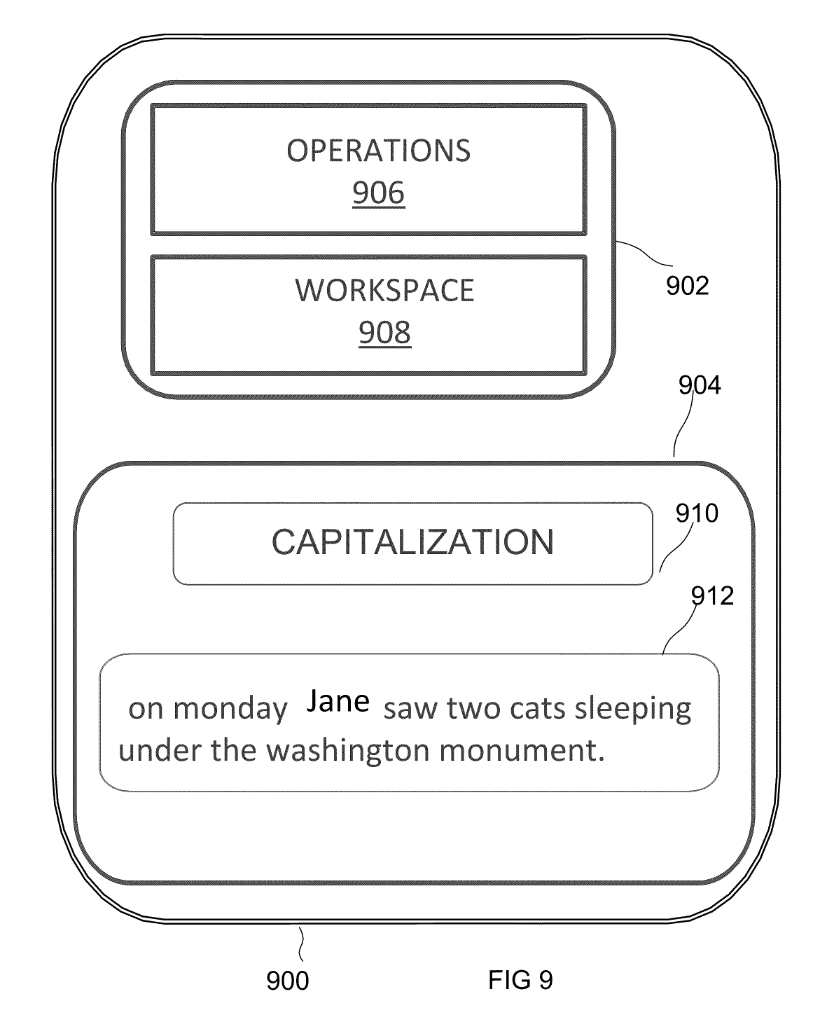

FIG. 9 illustrates a screenshot 900 depicting an exercise for grammar, according to an embodiment. The reader may be asked to categories a grammatical mistake, find a grammatical mistake and correcting grammatical mistakes. The reader is shown a passage and asked to click on all examples of specific types of errors. In one implementation the reader is asked to click on all pronouns. In one implementation the reader is asked to click on all verbs. In one implementation the reader is asked to click on all words that should be capitalized.

The screenshot 900 includes a format 902 of the exercise and contents 904 of the exercise. The format 902 includes format of operations 906 and format of workspace 908. The contents 904 of the exercise include operation capitalization 910 and sentence 912. During the exercise the reader is asked to identify all words that should be capitalized in the sentence 912 in the workspace. In one implementation the reader may be asked to correct specific mistake the reader found.

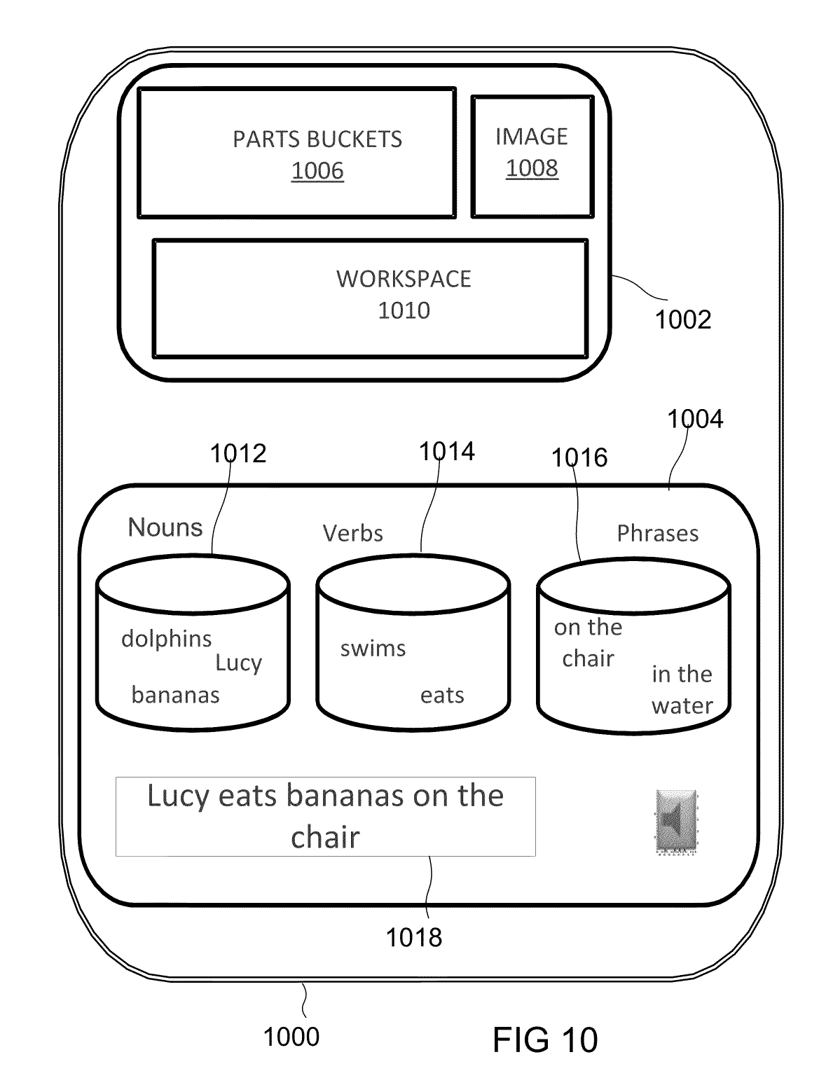

FIG. 10 illustrates a screenshot 1000 depicting an exercise to create sentences from parts, according to an embodiment. During this exercise the reader is asked to create sentences using the parts provided in different buckets. The parts in buckets may include nouns, pronouns verbs, prepositional phrases, and other parts. The buckets may include finite or infinite number of parts.

The screenshot 1000 includes a format 1002 of the exercise and contents 1004 of the exercise. The format 1002 includes format of parts of buckets 1006, format of an image 1008 and format of workspace 1010. The contents 1004 of the exercise includes a bucket 1012 for consisting of noun words, a bucket 1014 consisting of verbs, a bucket 1018 consisting of phrases and workspace 1018 for creating sentences using the words in the buckets 1012, 1014 and 1016. During the exercise the reader is asked to use the words from buckets 1012, 1014 and 1016 and create sentences in workspace 1018. In one implementation audio and visual help may be provided to the user.

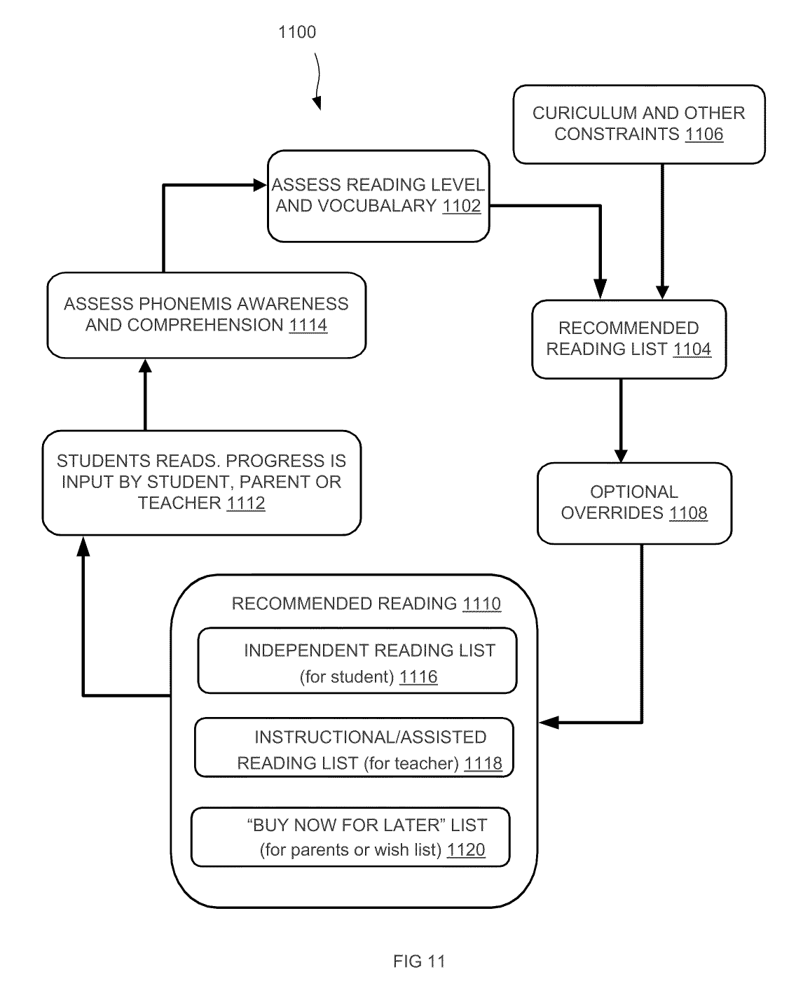

FIG. 11 illustrates a block diagram of a yet another system 1100 for generating a reading recommendation, according to one embodiment. The system 1100 may be used to generate reading recommendation for a student. At block 1102, a reading level and a vocabulary of the student is assessed. The reading level and the vocabulary of the student may be assessed by analyzing inputs from the reader for one or more assessment tests. At block 1104, a recommended reading list is generated for the reader. The reading recommendation may be generated based on the assessment of the reader.

At block 1106, curriculum and other constraints may be used to generate the recommended reading list 1104. The recommended reading list 1104 is provided with optional overrides 1108. The overrides may be used to modify the reading recommendations by changing texts of the contents, changing the order of the contents, and so on. The recommended reading list 1104 may be used to create a recommended reading 1110. The recommendation reading 11104 may include an independent reading list 1116 for the student, instructional/assisted reading list 1118 for an instructor and buy now for later list 1120.

At block 1112, a progress of the reader may be input by the student or the instructor (parent or a teacher) as the student reads. At block A1102, the phonemic awareness and reading comprehension of the student is assessed. The assessment may be used to update the reading label and vocabulary of the student.

According to an embodiment, the system 1100 is a cyclic and dynamic process. The system uses a continuous assessment for generating recommended reading for the student. The system 1100 may be programmed to assess the reading level and vocabulary of the student at a predetermined interval. In one implementation the system 1100 individually assess and remembers the vocabulary and the reading level for each student. In another implementation the system 1100 generate reading recommendation for parent or teacher use. In yet another implementation, a computer may not be required for reading to occur.

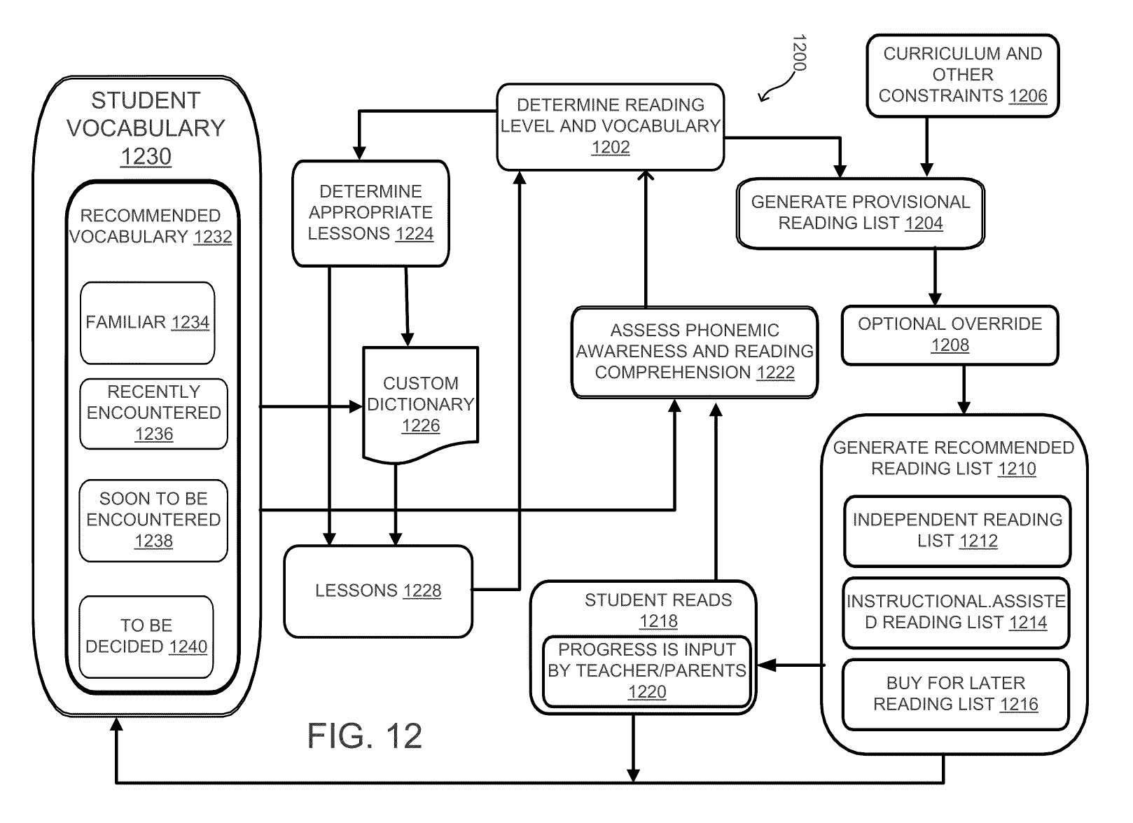

FIG. 12 illustrates a block diagram of a yet another system 1200 for generating a reading recommendation, according to one embodiment. At block 1202, reading ability and vocabulary of a student is determined. The reading ability and the vocabulary of the student may be determined by analyzing response of the student for one or more tests. The reading ability of the student may also be determined by the student's teacher or parent.

At block 1204, a provisional reading list is generated. The provisional reading list 1204 may be generated based on the determination made in block 1202 and curriculum and other constraints 1206. The provisional reading list 1204 is provided with optional overrides 1208. The optional overrides 1208 may be exercised by the student's instructor to modify the provisional reading list 1204. At block 1208, a recommended reading is generated for the student based on the provisional reading list and the optional overrides. The recommended reading 1208 includes an independent reading list 1212, instructional/assisted reading list 1214 and buy for later reading list 1216.

At block 1218, the student may read the reading recommendation. The student may read the reading recommendation on the reading device. The reading device may be a computing device, for example, a tablet personal computer, a laptop computer, a multimedia, device, etc. The reading device may be an Amazon Kindle device and/or a Apple iPad device. At block 1220, the teacher and/or the parent may input the progress made by the student. The teacher and/or the parent may input the progress report in the assessment block 1222.

At block 1230, a student vocabulary is created. The student vocabulary may comprise a list of recommended vocabulary 1232 for the student. The recommended vocabulary 1232 may comprise a list of familiar words 1234, recently encountered words 1236, soon to be encountered words 1238 and to be decided words 1240. The student vocabulary may be created based on the recommended reading list 1210 generated for the student and the progress report of the student at block 1220.

At block 1224, appropriate lessons may be determined for the student based on the reading level and the vocabulary of the student. At block 1226, a custom dictionary may be generated for the student. The custom dictionary 1126 may be generated based on the appropriate lessons 1124 for the student and the student vocabulary 1230. The custom dictionary 1226 may comprise a list of words which student should learn. At block 1228, lessons may be selected for the student based on the custom dictionary and the appropriate lessons determined at block 1224. The lessons 1228 may be provided to the student on the reading device. The lessons 1224 may be used for evaluating the student reading level after the student has completed learning the lessons.

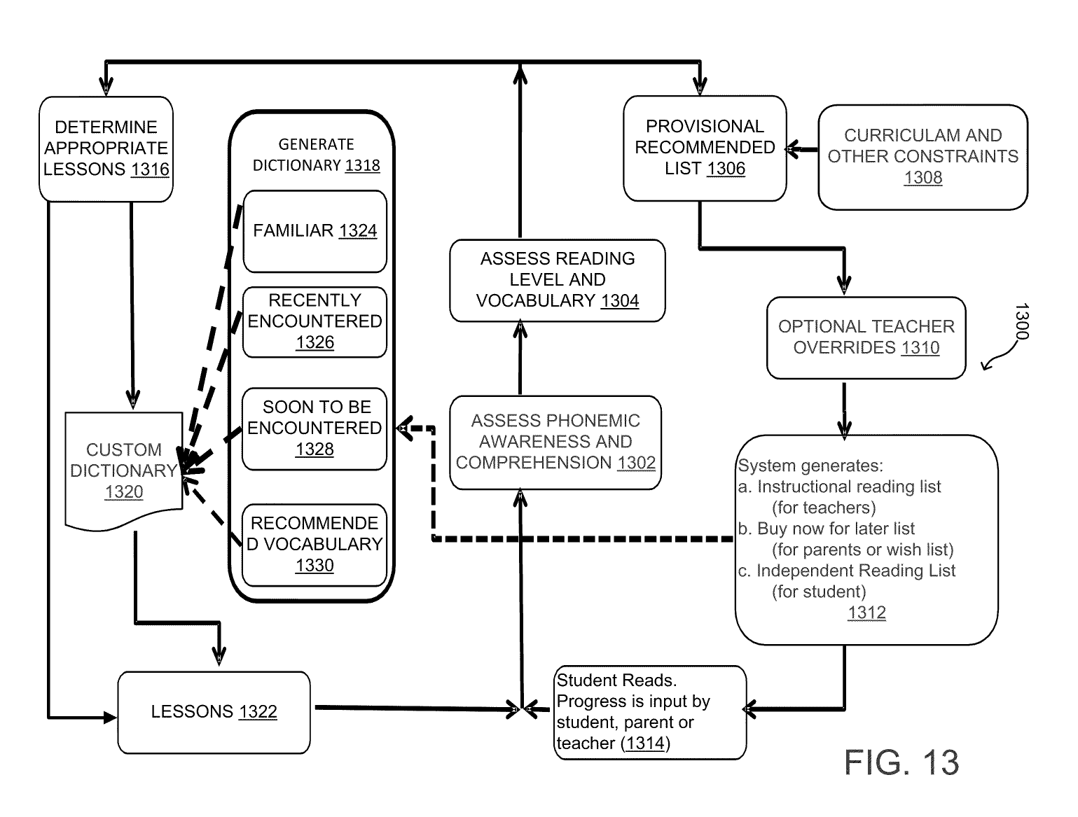

FIG. 13 illustrates a block diagram 1300 of a yet another system for generating reading recommendation, according to one embodiment. At block 1202, phonemic awareness and reading comprehension of a student is assessed. At block 1304, the reading level and vocabulary of the student is determined. The phonemic awareness, reading comprehension, reading level and the vocabulary of the student may be determined by analyzing response of the student for one or more tests.

At block 1306, a provisional reading list is generated. The provisional reading list 1306 may be generated based on the assessment made in block 1204 and curriculum and other constraints 1308. The provisional reading list 1306 is provided with optional overrides 1310. The optional overrides 1310 may be exercised by the student's instructor to modify the provisional reading list 1306. At block 1312, a recommended reading is generated for the student based on the provisional reading list and the optional overrides. The recommended reading 1312 includes an independent reading list for the student, instructional/assisted reading list for instructors and buy for later reading list for parents of wish list.

At block 1314, the student may read the recommended reading. The student may read the recommended reading on a reading device. The reading device may be an Amazon Kindle device and/or a Apple iPad device. The student, the teacher and/or the parents may input the progress made by the student. The teacher and/or the parent may input the progress report in the assessment block 1302.

At block 1318, a dictionary is created. The dictionary 1318 is created for each student. The student dictionary may comprise a list of words for the student. The dictionary 1318 may comprise a list of familiar words 1324, recently encountered words 1326, soon to be encountered words 1328 and recommended vocabulary 1330. The dictionary 1318 may be created based on the recommended reading list 1312 generated for the student.

At block 1316, appropriate lessons may be determined for the student based on the reading level and the vocabulary of the student. At block 1320, a custom dictionary may be generated for the student. The custom dictionary 1320 may be generated based on the appropriate lessons 1124 for the student and the dictionary 1318. The custom dictionary 1226 may comprise a list of words which student should learn. At block 1322, lessons may be selected for the student based on the custom dictionary and the appropriate lessons determined at block 1316. The lessons 1322 may be provided to the student on the reading device. The lessons 1322 may be used for evaluating the student reading level after the student has completed learning the lessons.

According to an embodiment each dictionary entry may contain some or all of the following: word, definition, categorization, phonetic pronunciation (may be locale specific), audio file of pronunciation (may be locale specific), appropriate reading level, example Image (if applicable), reading list books in which it is used, sentence with example of usage.

According to another embodiment, the dictionary may leverage the deep knowledge the system has of: the existing student vocabulary, phonemic awareness, comprehension and reading level, what they have read recently, what has been or soon will be recommended for the student to read. The dictionary may combines varying amounts from these various categories to create custom dictionaries that blend familiar and recently introduced words with those that may soon be encountered during either lessons or instructional or independent reading. Each lesson is based upon one or more dictionaries dynamically created from a database of possible words for that specific combination of student and lesson content. Dictionaries content can be any mix of: very familiar words (general vocabulary), slightly familiar words (from recent reading list), new words (for general vocabulary expansion), soon to be encountered words (extracted from unread texts on the recommended reading lists) and words from an optional recommended vocabulary list.

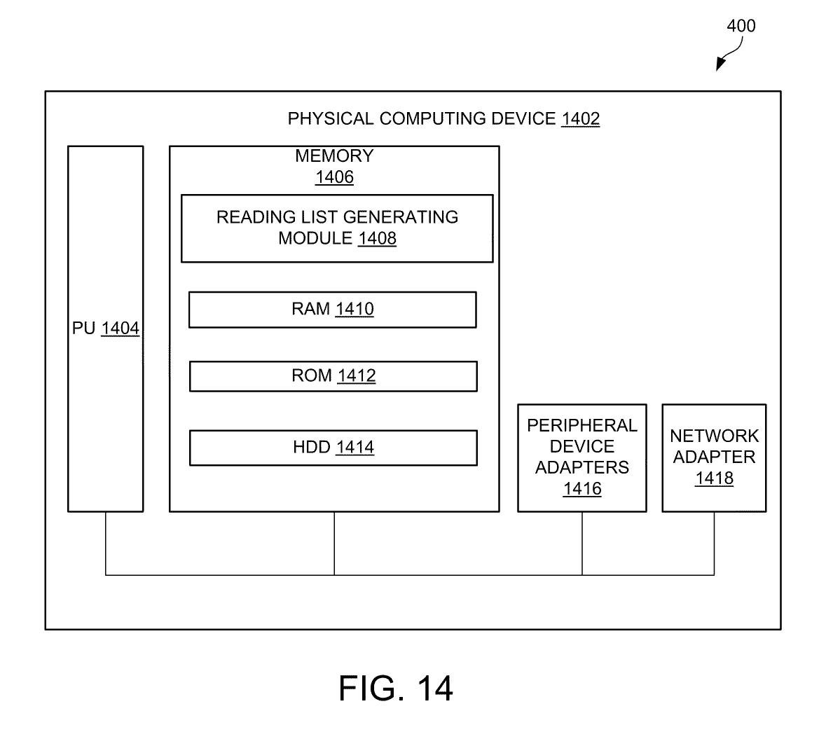

FIG. 14 illustrates a block diagram (1400) of a system to generate a learning list using a reading recommendation generating module 1408, according to one embodiment. Referring now to FIG. 14, an illustrative system (1400) to generate reading recommendation includes a physical computing device (1402). The physical computing device (1402) of the present example is a computing device configured to generate the reading recommendation by sending reading material as e-content to a reading device, executing an evaluation process to evaluate a reader's reading ability based on the reading material, executing a recommendation process to identify a reading recommendation for the reader based on the reader's reading ability; and providing the reading recommendation to the reader. Illustrative method to generate the reading recommendation will be set forth in more detail below.

To achieve its desired functionality, the physical computing device (1402) includes various hardware components. Among these hardware components may be at least one processing unit (PU) (1404), at least one memory unit (1406) and peripheral device adapters. These hardware components may be interconnected through the use of one or more busses and/or network connections.

The processing unit (1404) may include the hardware architecture necessary to retrieve executable code from the memory unit (1406) and execute the executable code. The executable code may, when executed by the processing unit (1404), cause the processing unit (1404) to implement at least the functionality of generating reading recommendation. In the course of executing code, the processing unit (1404) may receive input from and provide output to one or more of the remaining hardware units.

The memory unit (1406) may be configured to digitally store data consumed and produced by the processing unit (1404). Further, the memory unit (1406) includes the reading recommendation generating module 1408. The memory unit (1406) may also include various types of memory modules, including volatile and nonvolatile memory. For example, the memory unit (1406) of the present example includes Random Access Memory (RAM) 1410, Read Only Memory (ROM) 1412, and Hard Disk Drive (HDD) memory 1414. Many other types of memory are available in the art, and the present specification contemplates the use of any type(s) of memory in the memory unit (1406) as may suit a particular application of the principles described herein. In certain examples, different types of memory in the memory unit (1406) may be used for different data storage needs. For example, in certain embodiments the processing unit (1404) may boot from ROM, maintain nonvolatile storage in the HDD memory, and execute program code stored in RAM.

The hardware adapter in the physical computing device (1402) are configured to enable the processing unit (1404) to interface with various other hardware elements, external and internal to the physical computing device (1402). For example, peripheral device adapters (1416) may provide an interface to input/output devices to create a user interface and/or access external sources of memory storage. Peripheral device adapters (1416) may also create an interface between the processing unit (1404) and a printer or other media output device.

The above described embodiments with respect to FIG. 14 are intended to provide a brief, general description of the suitable computing environment 1400 in which certain embodiments of the inventive concepts contained herein may be implemented.

As shown, the computer program includes the reading recommendation generating module 1414 for generating the reading list for the reader. For example, the reading recommendation generating module 1408 described above may be in the form of instructions stored on a non-transitory computer-readable storage medium. An article includes the non-transitory computer-readable storage medium having the instructions that, when executed by the physical computing device 1402, causes the computing device 1408 to perform the one or more methods described with respect to FIGS. 1 to 13.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

What is claimed is:

1. A method, comprising:
sending reading material as e-content to a reading device;
executing an evaluation process to evaluate a reader's reading ability based on the reading material, wherein the evaluation process takes as first input data collected from the reading device; and
executing a recommendation process to identify a reading recommendation for the reader based on the reader's reading ability; and
providing the reading recommendation to the reader.

2. The method of claim 1, wherein the first input comprises metrics collected as the reader reads the reading material.

3. The method of claim 2, wherein metrics comprises information about dictionary look-ups the reader performed while reading.

4. The method of claim 2, wherein the metrics comprises the reader inputs to tests administered by the reading device and designed to test reading ability.

5. The method of claim 2, wherein the metrics comprise data indicative of at least one the reader's phonemic awareness, vocabulary, reading comprehension, and reading level.

6. The method of claim 1, wherein the evaluation process takes as second input an indication of the reader's reading ability by a third party.

7. The method of claim 1, wherein the reading recommendation comprises lists selected from the group consisting of reading for enjoyment, reading for pleasure, reading for personal development, reading for education and reading for buy now for later.

8. The method of claim 1, wherein the recommendation process takes the reader inputs into account.

9. The method of claim 8, wherein the reader inputs comprise at least one of inputs indicative of reading interests and reading level.

10. The method of claim 9, wherein the reading level is specified in terms of job titles.

11. A system for generating a reading recommendation comprising:
a processor; and
a memory operatively coupled to the processor, wherein the memory includes a reading recommendation generating module for generating a reading recommendation, having instructions capable of:
sending reading material as e-content to a reading device;
executing an evaluation process to evaluate a reader's reading ability based on the reading material, wherein the evaluation process takes as first input data collected from the reading device;
executing a recommendation process to identify a reading recommendation for the reader based on the reader's reading ability; and
providing the reading recommendation to the reader.

12. The system of claim 11, wherein the first input comprises metrics collected as the reader reads the reading material.

13. The system of claim 12, wherein metrics comprises information about dictionary look-ups the reader performed while reading.

14. The system of claim 12, wherein the metrics comprises the readers inputs to tests administered by the reading device and designed to test reading ability.

15. The system of claim 12, wherein the metrics comprise data indicative of at least one the reader's phonemic awareness, vocabulary, reading comprehension, and reading level.

16. A non-transitory computer-readable storage medium for generating a reading recommendation, having instructions that, when executed by a computing device, causes the computing device to perform a method comprising:
sending reading material as e-content to a reading device;
executing an evaluation process to evaluate a reader's reading ability based on the reading material, wherein the evaluation process takes as first input data collected from the reading device;
executing a recommendation process to identify a reading recommendation for the reader based on the reader's reading ability; and
providing the reading recommendation to the reader.

17. The computer program product of claim 16, wherein the first input comprises metrics collected as the reader reads the reading material.

18. The computer program product of claim 17, wherein metrics comprises information about dictionary look-ups the reader performed while reading.

19. The computer program product of claim 17, wherein the metrics comprises the reader's inputs to tests administered by the reading device and designed to test reading ability.

20. The computer program product of claim 17, wherein the metrics comprise data indicative of at least one the reader's phonemic awareness, vocabulary, reading comprehension, and reading level.
